(19) United States
(12) Patent Application Publication
(10) Pub. No.: US 2022/0084071 A1
(43) Pub. Date: Mar. 17, 2022

(54) METHOD AND SYSTEM OF ENTITY INTERACTION HISTORY SIGNATURES

(71) Applicants: MICHAEL TOLSON, mountain view, CA (US); BRAD DEGRAF, mountain view, CA (US); MICHAEL KHAIT, mountian view, CA (US); KAUSHAL MEHTA, mountian view, CA (US)

(72) Inventors: MICHAEL TOLSON, mountain view, CA (US); BRAD DEGRAF, mountain view, CA (US); MICHAEL KHAIT, mountian view, CA (US); KAUSHAL MEHTA, mountian view, CA (US)

(21) Appl. No.: 17/363,548

(22) Filed: Jun. 30, 2021

Related U.S. Application Data
(63) Continuation-in-part of application No. 16/600,503, filed on Oct. 13, 2019.
Application No. 16/600,503 is a continuation-in-part of application No. 16/368,849, filed on Mar. 28, 2019, now abandoned.
(60) Provisional application No. 62/648,944, filed on Mar. 28, 2018.

(51) Int. Cl. G06Q 30/02; G06F 16/9536; G06Q 30/06; G06F 21/55

(52) U.S. Cl. CPC G06Q 30/0269; G06F 21/554; G06Q 30/0631; G06F 16/9536

(57) ABSTRACT

In one aspect, a computerized method for implementing entity interaction history signatures includes the step of providing a set of entities in an online network. The method includes the step of comparing a first entity of the set of entities with a second entity of the set of entities using a first entity interaction history signature of the first entity and second entity interaction history signature of the second entity. The method includes the step of based on the comparison of the first entity with the second entity computing a similarity measure. The method includes the step of aggregating a set of entity interaction history signatures for the set of entities to create a group signature.

### CLAIM OF PRIORITY AND INCORPORATION BY REFERENCE

This application claims priority from U.S. Provisional Application No. 62/648,944, filed on 28 Mar. 2018. This application is hereby incorporated by reference in its entirety for all purposes.

### FIELD OF THE INVENTION

The invention is in the field of online social media networks and more specifically to a method, system and apparatus for entity interaction history signatures.

### DESCRIPTION OF THE RELATED ART

Social media ecosystems occur in many places on the Internet. Within a social media ecosystem, as with any social media milieu, various entities can interact. These entities can include, inter alia: people, businesses, web sites, groups, individual content items and collections thereof. The identity of entities in social ecosystems can be modeled as an accumulation of traces of interactions with other social entities. In this way, every entity can carry a unique ‘signature’ that can be utilized to improve the experience of users in an online social media ecosystem.

### SUMMARY

In one aspect, a computerized method for implementing entity interaction history signatures includes the step of providing a set of entities in an online network. The method includes the step of comparing a first entity of the set of entities with a second entity of the set of entities using a first entity interaction history signature of the first entity and second entity interaction history signature of the second entity. The method includes the step of based on the comparison of the first entity with the second entity computing a similarity measure. The method includes the step of aggregating a set of entity interaction history signatures for the set of entities to create a group signature.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for utilizing entity interaction history signatures, according to some embodiments.

FIG. 2 illustrates an example process for utilizing the signature of a user, according to some embodiments.

FIG. 3 illustrates an example process for utilizing the signature of a piece of content, according to some embodiments.

FIG. 4 illustrates an example process for utilizing the signature real-time stream of content, according to some embodiments.

FIG. 5 illustrates an example process for utilizing an audience for content within a topic, according to some embodiments.

FIG. 6 illustrates an example process for utilizing a content provider, according to some embodiments.

FIG. 7 is a block diagram of a sample computing environment that can be utilized to implement some embodiments.

The Figures described above are a representative set and are not an exhaustive with respect to embodying the invention.

### DESCRIPTION

Disclosed are a system, method, and article of manufacture of entity interaction history signatures. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Bag-of-words (BOW) model is a simplifying representation used in natural language processing and information retrieval (IR).

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Similarity measure is a real-valued function that quantifies the similarity between two objects.

Process Overview

Processes provided herein provide an innovative and proprietary approach to identity within social media ecosystems. The identity of entities in social ecosystems can be modeled as an accumulation of traces of interactions with other social entities. In the social media milieu, these entities can be people, businesses, web sites, groups, individual content items and collections thereof. In one example, every entity can carry a unique ‘signature’ that is a compact abstract numerical indicator of its interaction history.

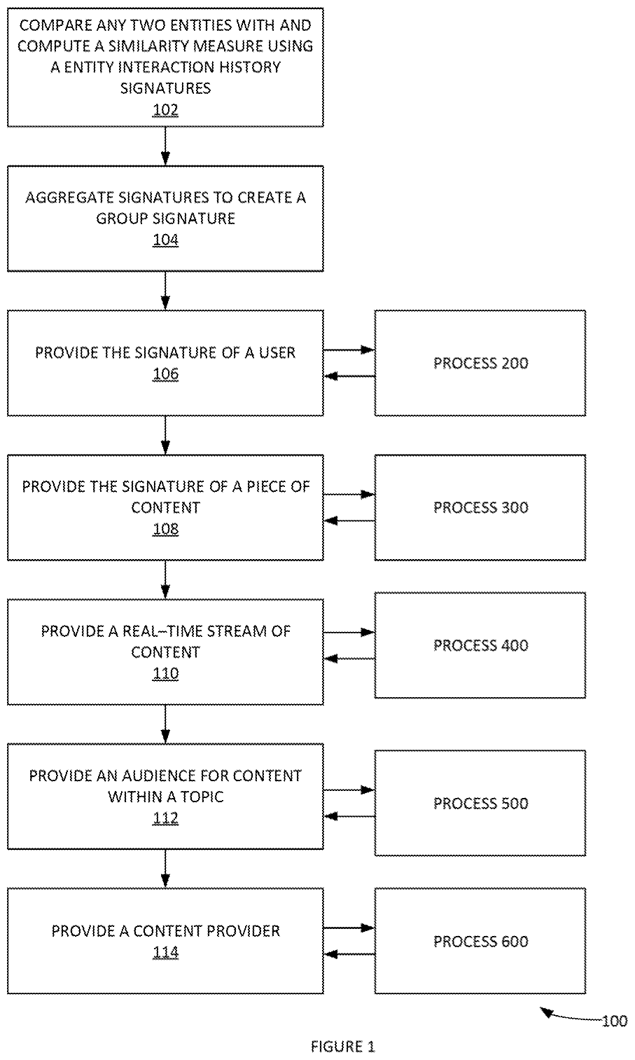

FIG. 1 illustrates an example process 100 for utilizing entity interaction history signatures, according to some embodiments. Process 100 can provide an entity interaction history signature(s) (‘signature’) for each entity. In step 102, process 100 can compare any two entities with and compute a similarity measure using an entity interaction history signatures. In step 104, process 100 can aggregate signatures to create a group signature. In step 106, process 100 can provide the signature of a user and implement process 200. In step 108, process 100 can provide the signature of a piece of content and implement process 300. In step 110, process 100 can provide a real-time stream of content and implement process 400. In step 112, process 100 can provide an audience for content within a topic and implement process 500. In step 114, process 100 can provide a content provider and implement process 600.

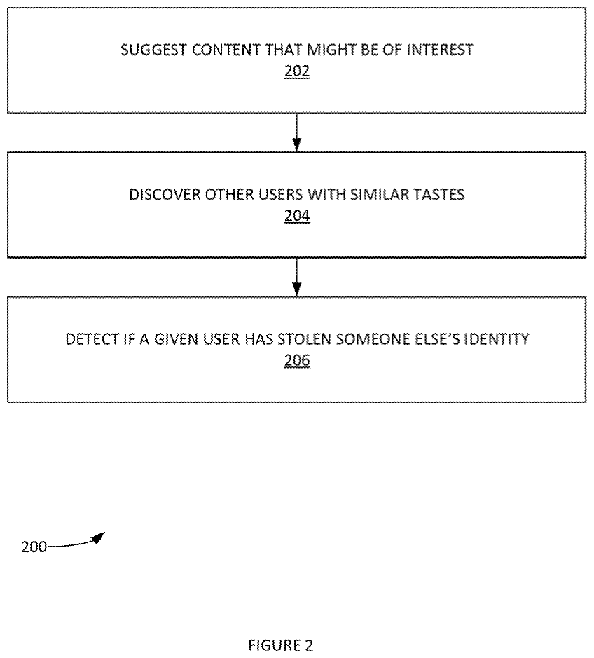

FIG. 2 illustrates an example process 200 for utilizing the signature of a user, according to some embodiments. In step 202, process 200 can suggest content that might be of interest (e.g. personalized news feeds, etc.). In step 204, process 200 can discover other users with similar tastes (e.g. social search, etc.). In step 206, process 200 can detect if a given user has stolen someone else's identity.

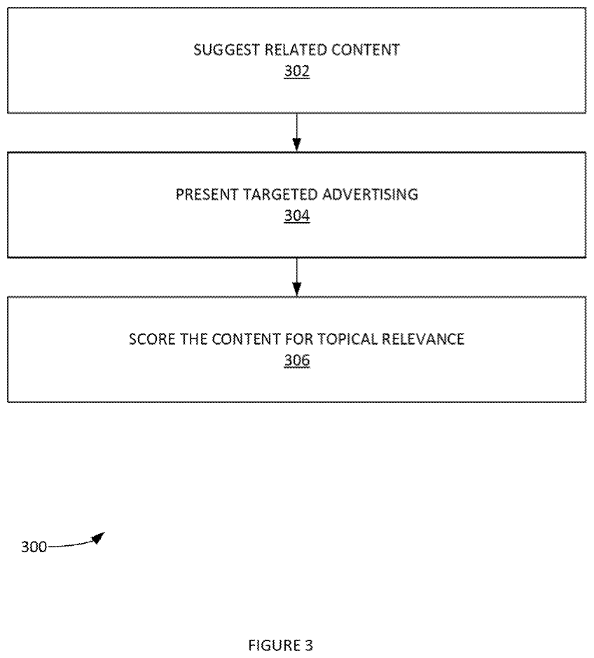

FIG. 3 illustrates an example process 300 for utilizing the signature of a piece of content, according to some embodiments. In step 302, process 300 can suggest related content. In step 304, process 300 can present targeted advertising. In step 306, process 300 can score the content for topical relevance.

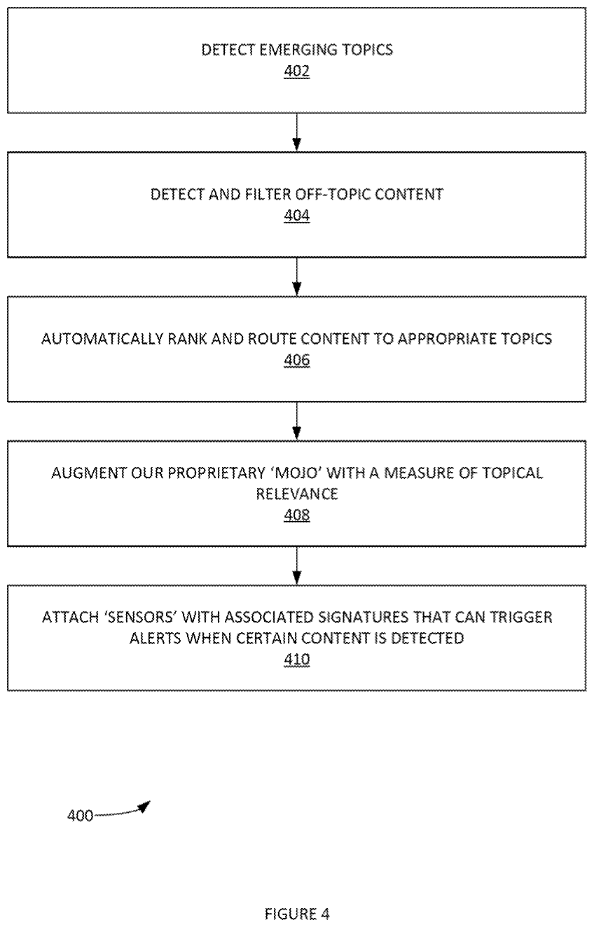

FIG. 4 illustrates an example process 400 for utilizing the signature real-time stream of content, according to some embodiments. In step 402, process 400 can detect emerging topics (e.g. trend spotting, etc.). In step 404, process 400 can detect and filter off-topic content. In step 406, process 400 can automatically rank and route content to appropriate topics or zones of interest. In step 408, process 400 can augment our proprietary ‘mojo’ with a measure of topical relevance. In step 410, process 400 can attach ‘sensors’ with associated signatures that can trigger alerts when certain content is detected.

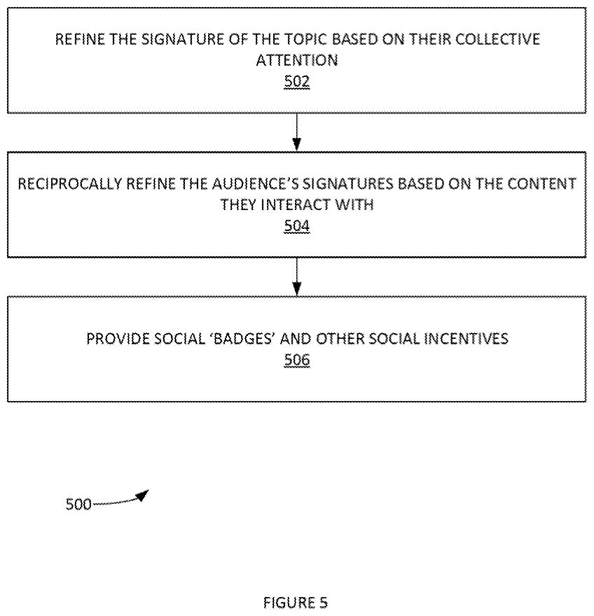

FIG. 5 illustrates an example process 500 for utilizing an audience for content within a topic, according to some embodiments. In step 502, process 500 can refine the signature of the topic based on their collective attention. In step 504, process 50 can reciprocally refine the audience's signatures based on the content they interact with. In step 506, process 500 can provide social ‘badges’ and other social incentives.

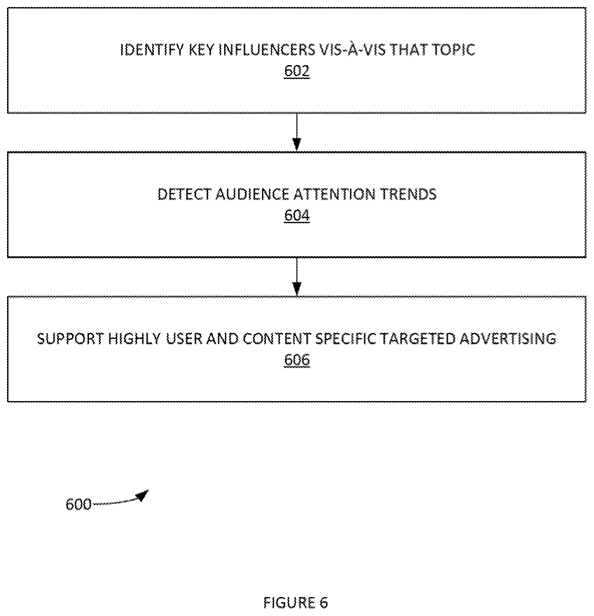

FIG. 6 illustrates an example process 600 for utilizing a content provider, according to some embodiments. In step 602, process 600 can identify key influencers vis-à-vis that topic. In step 604, process 600 can detect audience attention trends. In step 606, process 600 can support highly user and content specific targeted advertising.

Additionally, process 100 can be used for the following, inter alia: de-duping in feeds; outlier removal in feeds; as a ranking component in feeds; projections; as features for machine learning (ML); clustering for subtopic discovery; etc. Process 100 can also be used for: training ML models based on attentive acts for personalization; recommendations of content, SMEs, topics; clustering for creating a feature basis; etc.

Process 100 can include the following features, inter alia: infinite vocabulary (e.g. using BOW, n-grams, etc.); mixed embeddings of entity types (e.g. BOW plus users); signatures generated and embedded on the fly; semi-automated content labeling for ML training; infilling/imputation for missing features; aggregation (e.g. with weighting and/or with exponential decay); etc. Process 100 can have variable capacity for efficiency. Process 100 can implement ‘folding’ for efficiency, as well as, mixed embeddings for different ‘aspects’.

Process 100 can be implemented within Social Subgraphs (e.g. to determine influencers). Process 100 can implement edge weighting for mojo derived from affinity (e.g. determine similarity). Process 100 can provide inferential badging and implement influencer ranking based on topicality.

Process 100 can be implemented within taxonomies. For example, process 100 can implement semi-automated feature generation for ML. Process 100 can provide recommendations for interests and topics as adversarial authorities.

Process 100 can be implemented within a learning milieu. Process 100 recommend X in [content, topics, groups, people]. This can be done on the fly. For example, process 100 can provide a pathway as a function of progress (e.g. ‘velocity’ on signature space). Process 100 can be implemented within other contexts (e.g. from a sociative blog). A taxonomy of a conspiracy of experts can be implemented.

Process 100 can be implemented to provide identity within social media ecosystems. The identity of entities in social ecosystems can be modeled as an accumulation of traces of interactions with other social entities. In the social media milieu, these entities can be people, businesses, web sites, groups, individual content items and collections thereof. In process 100 every entity can carry a unique ‘signature’ that is a compact abstract numerical indicator of its interaction history.

Exemplary Environment and Architecture

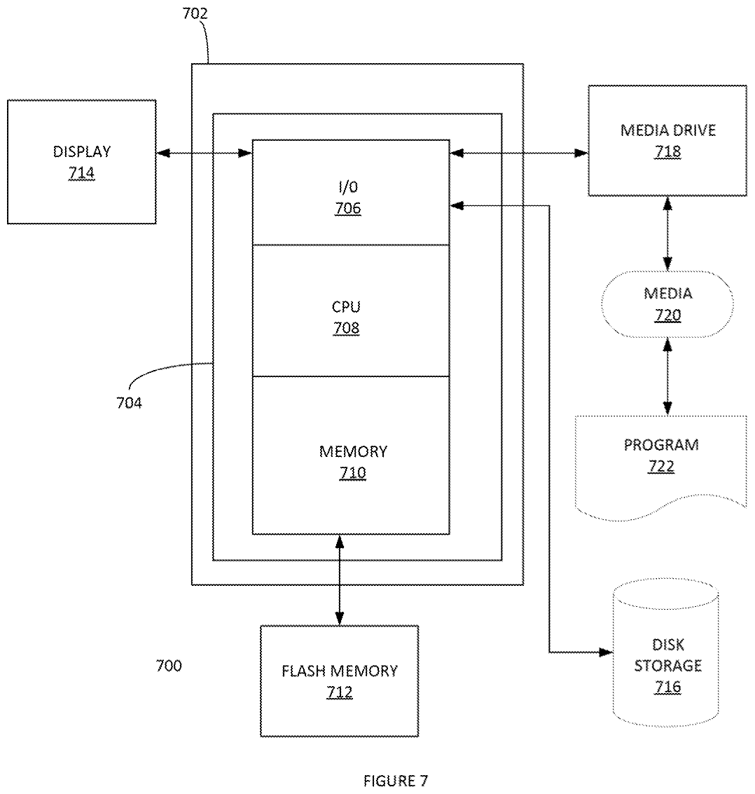

FIG. 7 is a block diagram of a sample computing environment 700 that can be utilized to implement some embodiments. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 710 that can be employed to facilitate communications between the client(s) 702 and the server(s) 704. The client(s) 702 are connected to one or more client data store(s) 706 that can be employed to store information local to the client(s) 702. Similarly, the server(s) 704 are connected to one or more server data store(s) 708.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized method for implementing entity interaction history signatures comprising:
providing a set of entities in an online network;
comparing a first entity of the set of entities with a second entity of the set of entities using a first entity interaction history signature of the first entity and second entity interaction history signature of the second entity;
based on the comparison of the first entity with the second entity computing a similarity measure; and
aggregating a set of entity interaction history signatures for the set of entities to create a group signature.

2. The computerized method of claim 1, wherein an entity comprises a user of the online network, a business, a web site, a specified group of persons or a set of contents of an item.

3. The computerized method of claim 2 further comprising:
providing an entity interaction history signature of the user of the online network.

4. The computerized method of claim 3 further comprising:
based on the entity interaction history signature of the user:
suggest a content online network;
generating a set of content of a personalized news feed for the user; and
discovering a set of other users with similar interests.

5. The computerized method of claim 4 further comprising:
detecting a stolen identity of the user.

6. The computerized method of claim 2, further comprising:
based on the entity interaction history signature of the content, providing the signature of a piece of content of the online network.

7. The computerized method of claim 6 further comprising:
based on the entity interaction history signature of the content, suggesting a related content to the piece of content based on a similarity score between the related content and the content.

8. The computerized method of claim 7 further comprising:
based on the entity interaction history signature of the content, presenting a targeted advertisement to a user based on a similarity score between the user and the content;
based on the entity interaction history signature of the content, scoring the content based on a specified topical relevance.

9. The computerized method of claim 2, further comprising:
providing a real-time stream of content.

10. The computerized method of claim 9, further comprising:
based on the entity interaction history signature of the real-time stream of content:
detecting one or more emerging topics of the real-time stream of content;
detecting and filtering out off-topic content of the real-time stream of content;
automatically ranking and routing the real-time stream of content to appropriate topics or zones of interest.

11. The computerized method of claim 10, further comprising:
based on the entity interaction history signature of the real-time stream of content, attaching a virtual sensors with associated entity interaction history signatures that trigger alerts when a specified content is detected in the real-time stream of content.

12. The computerized method of claim 2, further comprising:
providing an audience for a content topic within a specified topic.

13. The computerized method of claim 12, further comprising:
based on the entity interaction history signature of the audience and the content topic:
refining the entity interaction history signature of the content topic based on a collective attention of the audience;
reciprocally refining each entity interaction history signature of the audience based on any content the audience interacts with; and
providing a virtual social badges to specified members of the audience.

14. The computerized method of claim 13 further comprising:
providing a content provider.

15. The computerized method of claim 14, further comprising:
based on the entity interaction history signature of the content provider and the audience:
identifying a set of key influencers with respect to a specified topic;
detecting an audience attention trend; and
implementing a user and content specific targeted advertising campaign in the online network.

16. The computerized method of claim 1, wherein the online network comprises an online educational platform.
